(19) United States
(12) Patent Application Publication
(10) Pub. No.: US 2006/0115388 A1
(43) Pub. Date: Jun. 1, 2006

(54) Dispersal air scrubber

(76) Inventor: William D. Sanderson, San Francisco, CA (US)

Correspondence Address: MANELLI DENISON & SELTER, 2000 M STREET NW SUITE 700, WASHINGTON, DC, 20036-3307, US

(21) Appl. No.: 10/537,739

(22) PCT Filed: Dec. 12, 2003
(86) PCT No.: PCT/KR03/02735

§ 371 Date: Jun. 8, 2005

(30) Foreign Application Priority Data
Dec. 13, 2002 (KR) 10-2002-0079492

(51) Int. Cl. B01D 53/34

(52) U.S. Cl. 422/168

(57) ABSTRACT

The present invention embodies a Dispersal Air Scrubbing device. Dispersal Air Scrubbing is generally designed for indoor air purification. The air scrubber includes an elongated body having several packing casters at its lower portion and being provided with a fog guide at its upper portion and having air inlet apertures formed at both its sides; a double inlet blower mounted in the lower body shell defined at the lower portion of the body; an air chamber provided on the double inlet blower acting as a sound damper and; an ultrasonic transducer module mounted on the air chamber acting as an atomizer and having a hose discharging water vapor and connecting to the fog guide.

### FIELD OF THE INVENTION

The present invention relates to a novel air-scrubbing device that projects an aqueous oxidizing agent in the form of an ultra fine vapor that will oxidize airborne contaminants throughout a treatment area. A device enabling the projection of oxidizing vapor and subsequent removal of airborne contaminants throughout an indoor space to effect air scrubbing is hereto referred to as a Dispersal Air Scrubber.

### BACKGROUND OF THE INVENTION

It is known that aqueous liquid spray air purification techniques have been used in removal of a number of common air pollutants from contaminated interior environmental air. Nevertheless, liquid spray air purification systems have failed to gain wide acceptance in other than large industrial applications due to practical limitations such as noise level, size, and cost.

Traditional air scrubbing techniques have relied upon large air moving devices (blowers) to move air through liquid contacting systems that run counter-current to air flow. This requires the use of voluminous reaction chambers. The Dispersal Air Scrubber circumvents the use of reaction chambers and instead relies upon the air space in the immediate vicinity of the unit as the treatment reaction medium.

Clearly, a small easily portable Dispersal Air Scrubber would benefit small indoor spaces where the use of high volume air filtration, scrubbing equipment, and large reaction chambers are precluded due to cost or physical constraints.

### SUMMARY OF THE INVENTION

It is therefore an object of the present invention to provide a system for air scrubbing employing a Dispersal Air Scrubber. Dispersal Air Scrubbing utilizes the physical space in the vicinity of the unit as the treatment area. This has above-mentioned advantages over traditional scrubbing techniques.

The Dispersal Air Scrubber of the present invention includes: an elongated cubical-shaped body having a plurality of packing casters at its lower portion and is provided with a fog guide at its upper portion and consisting of air inlet apertures located on both sides at the lower portion of the body; a double inlet blower mounted in the lower body shell; and defined at the lower portion of the body; an air chamber provided on the double inlet blower acting as a sound damper; and an ultrasonic transducer module mounted on the air chamber acting as an atomizer which consists of one or more hoses that conduct water vapor to the connecting fog guide.

In accordance with the present invention, a plurality of vapor projectors are mounted in the fog guide and the double inlet blower provides upstream air flow from the air inlet apertures, through the air chamber and the internal space of the body, to the fog guide.

### BRIEF DESCRIPTION OF THE DRAWINGS

The above objects, and other features and advantages of the present invention will become more apparent after reading the following detailed description to be taken in conjunction with the drawings, in which:

FIG. 1 is a perspective view illustrating a Dispersal Air Scrubber in accordance with an embodiment of the present invention;

FIG. 2 is a front sectioned view of the Dispersal Air Scrubber of FIG. 1 eliminating a front cover;

FIG. 3 is a side sectional view of the Dispersal Air Scrubber of FIG. 1 illustrating the internal construction thereof.

### DETAILED DESCRIPTION OF PREFERRED EMBODIMENTS

Reference will now be made in greater detail to a preferred embodiment of the invention, an example of which is illustrated in the attached drawings. Wherever possible, the same reference numerals will be used throughout the drawings and the description to refer to the same or similar parts.

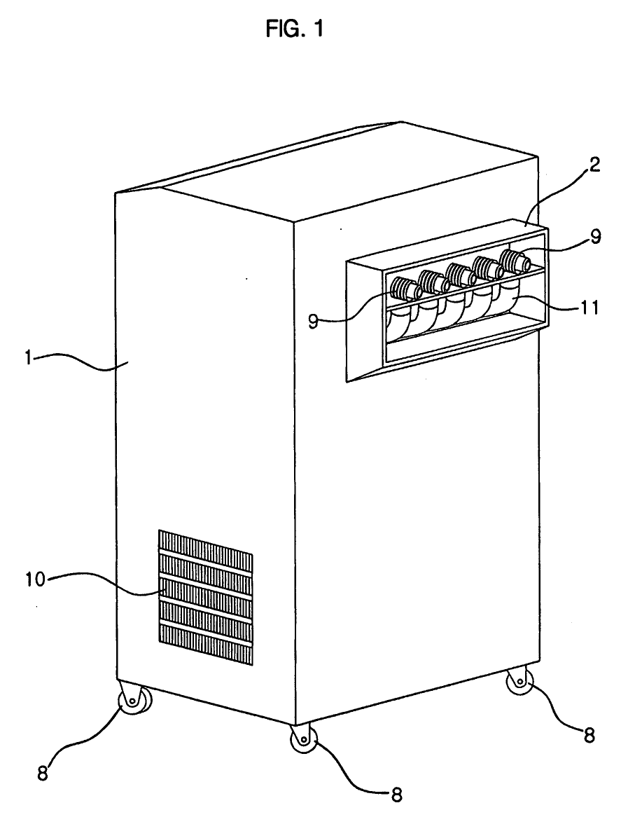

Referring to FIG. 1, there is a perspective view shown illustrating a Dispersal Air Scrubber in accordance with an embodiment of the present invention. The Dispersal Air Scrubber comprises an elongated cubical body 1. The body 1 has a plurality of packing casters 8 at its lower portion.

Therefore, the air scrubber of the invention can easily be moved to any treatment location whether it is a room, storage area or a particular section of a plant emitting airborne contaminants.

The body is 0.93 m in height and consists of a fog guide 2 at its upper portion. In the fog guide 2, a plurality of vapor projectors 9 are mounted at an upwardly inclined horizontal direction. The upwardly inclined horizontal projection orientation improves the mixing of aqueous oxidizing vapor and ambient air.

The projection of ultra fine vapor particles (UFVPs) (water particles under 5 microns in diameter) into an air stream creates a large surface area with in which to effect chemical reactions. These reactions occur at the interface (surface) of the particle and the ambient air. When a given volume of liquid is atomized into 1 micron sized particles, it creates many orders of magnitude more surface area than when simply misted or sprayed (usually greater than 10 microns).

This has several advantages:

1) Utilizing a stream of UFVPs (as to opposed to conventional misting medium) provides an increased reactive surface area for chemical reactions to take place in.

2) The properties of an UFVP stream more closely resemble gases than liquids. The stream therefore interacts more readily with airborne contaminants than do agents projected in a denser liquid/mist state.

3) The large surface area to mass ratio of UFVP ensures that they will be readily dispersed by the mildest air currents.

In the present invention, an aqueous oxidizing agent is atomized into ultra fine vapor particles (UFVP). A UFVP stream is entrained into an airflow generated by the double-inlet blower at the air projectors mounted on the fog guide.

This results in the UFVP stream being propelled into a desired treatment area causing micro turbulence and hence, vigorous mixing of the UFVP with the ambient air. During this mixing process each particle achieves optimal opportunity to collide and interact with contaminants suspended in the ambient air. Impurities in the air are subsequently adsorbed and oxidized on the surface of the UFVP to the greatest advantage.

The atomized oxidizing agent is carried in higher concentration in the UFVP stream than in the air stream. This means that there is less overall demand for the total oxidizing agent required in a given air cleaning operation and also reduced exposure of personnel to the agent.

Also, air inlet apertures 10 are formed at both sides of the body 1.

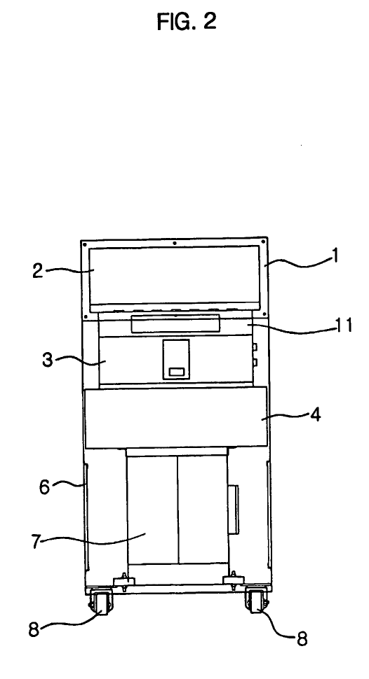

In FIG. 2, the air scrubber is illustrated in a front view with front cover eliminated from view. A lower body shell 6 is defined at the lower portion of the body 1. A double inlet blower 7 is mounted in the lower body shell 6.

For an example, the double inlet blower 7 has an air moving capacity of greater than 700 cfm so that the air scrubber of the present invention can easily treat indoor areas of 500 square feet at ten room changes per hour.

An air chamber 4 is provided on the double inlet blower 7. The air chamber 4 acts as a sound damper so that the air scrubber of the invention can be designed to run quietly below 58 decibels.

An ultrasonic transducer module 3 is mounted on the air chamber 4. The module 3 acts as an atomizer and is represented in prior art.

The ultrasonic transducer module is attached by means of liquid line to a replaceable cartridge. The cartridge is inserted into the Dispersal Air Scrubber unit. The cartridge would contain a concentrated solution of the oxidizing agent, which would mix with water from a supplied water source.

This development is for the convenience of unit operators who could avoid having to handle large volumes of dilute oxidizing agent. A typical cartridge might have to be replaced one time per week or month.

The selected ultrasonic module can generate one micron sized particles at rates of up to three kilograms per hour from an aqueous oxidizing solution. Also, the liquid oxidizer is supplied into the humidifier module with a pumping device.

The ultrasonic transducer module 3 has a hose 11 discharging water vapor and the end of the hose 11 is connected to the fog guide 2.

The Dispersal Air Scrubber of the present invention can project an aqueous oxidizing agent in the form of an ultra fine vapor throughout a treatment area.

The vaporized oxidizing agent as projected from the present invention can readily dispose of environmental pollutants such as certain volatile organic compounds, biological contaminants (mold/allergen spores, etc.), toxic gases such as hydrogen sulfide, and odorous compounds including mercaptans and volatile amines.

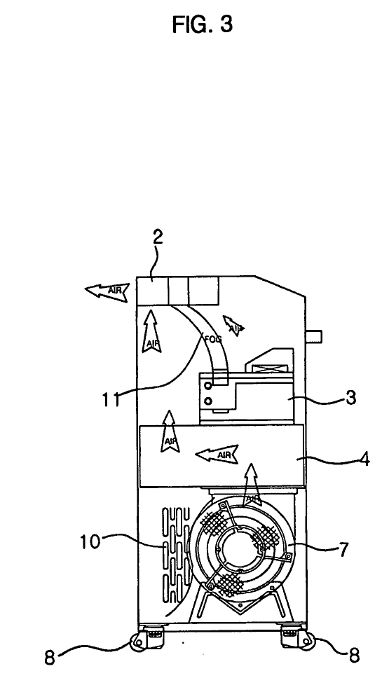

In FIG. 3, the Dispersal Air Scrubber is illustrated in a side sectional view. Referring to FIG. 3, ambient air is drawn into the double inlet blower through the air inlet apertures 10 and is conducted into the air chamber 4 and through internal space of the unit body.

Finally, the air is discharged from the fog guide 2 together with vapor. The fog guide 2 is specially designed to avoid drops of water vapor from condensing and dripping back into the unit. The double inlet blower provides upstream airflow from the air inlet apertures 10, through the air chamber 4 and the internal space of the body, to the fog guide 2.

A concentrated solution of the oxidizing agent is supplied to the ultrasonic transducer module 3 from a concentrate assembly 20 inside the unit and water is supplied to the ultrasonic transducer module 3 from a water source 21 outside the unit through water line.

It is understood that the Dispersal Air Scrubber of the current invention may be operated manually or automatically through a timer that is programmable.

In accordance with the features of the invention, the Dispersal Air Scrubber operates quietly at high speed and permits effective air circulation and treatment and is used in various applications:

Animal Husbandry: Reduction of toxic gases from confined animal feeding operations such as hydrogen sulfide. It also readily oxidizes odorous substances such as volatile amines and mercaptans.

Medical facilities: Reduction of odors from bedpans, soiled linens, wound cleaning, and maintenance cleaning.

The Air Scrubber generates a sanitizing vapor that will also kill airborne bacteria.

Mortuary: Reduction of volatile amines (cadaverine) and fumes from embalming fluids containing toxic formaldehyde formulations.

Manufacturing: Suppression of certain volatile organic compounds in the workplace while reducing employee exposure to these carcinogens.

Wastewater: Elimination of odors and corrosion prevention from hydrogen sulfide in small areas such as press rooms, wet well, lift stations, and equipment control areas.

Hospitality: Elimination of food odors, tobacco smoke, and body odor. Decontaminating guest rooms of allergens, molds, and other biological pollutants.

In the drawings and specifications provided, there have been disclosed typical preferred embodiments of the current invention and, although specific terms are employed, they are used in a generic and descriptive sense only and not for purposes of limitation, the scope of the invention being set forth in the following claims.

1. A Dispersal Air Scrubber comprising:
an elongated cubical-shaped body having a plurality of packing casters at its lower portion, a fog guide at its upper portion and air inlet apertures formed at both sides;
a double inlet blower mounted in lower body shell defined at the lower portion of the said body;
an air chamber acting as a sound damper provided on the said double inlet blower; and
an ultrasonic transducer module acting as an atomizer mounted on the said air chamber and having a hose conducting the oxidizing vapor and connecting it to the said fog guide.

2. The Dispersal Air Scrubber as set forth in claim 1, wherein several vapor projectors are mounted in the fog guide.

3. The Dispersal Air Scrubber as set forth in claim 1, wherein the said double inlet blower provides upstream air flow from the air inlet apertures, through the air chamber and the internal space of the body, to the fog guide.

4. A Dispersal Air Scrubber comprising:
a body having a plurality of packing casters at its lower portion, a fog guide disposed at an upper portion and at least one air inlet aperture formed on a side;
an air chamber disposed in said body in communication with the fog guide and air inlet, and acting as a sound damper during operation;
a blower constructed and arranged for forcing air through the inlet, the air chamber and out the fog guide; and
an ultrasonic transducer module in communication with the air chamber and a source of liquid oxidizer, the ultrasonic transducer being constructed and arranged to provide atomized oxidizer to air flowing through the air chamber during operation.

5. The dispersal air scrubber according to claim 4, wherein the blower is a double-inlet blower.

6. The dispersal air scrubber according to claim 4, further comprising two inlets located on the sides of the body.

7. The dispersal air scrubber according to claim 4, wherein at least one vapor projector is disposed in the fog guide.

8. The dispersal air scrubber according to claim 5, wherein the double-inlet blower provides air flow of greater than 700 cfm.

9. The dispersal air scrubber according to claim 4, wherein the ultasonic transducer produces up to three kilograms per hour of micron sized particles during operation.

10. The dispersal air scrubber according to claim 4, wherein the fog guide is constructed and arranged to avoid drops of water vapor from condensing and dripping back into the body.

11. The dispersal air scrubber according to claim 4, further comprising a source of water in communication with the ultrasonic transducer.

12. A method of scrubbing air using an air scrubber comprising a body having a plurality of packing casters at its lower portion, a fog guide at an upper portion and at least one air inlet aperture formed on a side, an air chamber disposed in said body in communication with the fog guide and air inlet, and acting as a sound damper, a blower constructed and arranged for forcing air through the inlet, the air chamber and out the fog guide, and an ultrasonic transducer module in communication with the air chamber and a source of liquid oxidizer, the ultrasonic transducer being constructed and arranged to provide atomized oxidizer to air flowing through the air chamber, the method comprising
using the ultrasonic transducer to provide atomized oxider to the air chamber; and
using the blower to blow air through the inlet and into the air chamber to form scrubbed air and allowing the scrubbed air to exit the body through the fog guide.

13. The method according to claim 12, wherein air flow is provided using a double-inlet blower.

14. The method according to claim 12, further comprising using two inlets located on the sides of the body to provide air flow to the air chamber.

15. The method according to claim 12, further comprising using at least one vapor projector disposed in the fog guide to direct the scrubbed air flow leaving the body.

16. The method according to claim 12, wherein air flow of greater than 700 cfm is provided.

17. The method according to claim 12, wherein up to three kilograms per hour of micron sized particles are produced by the transducer during operation.

18. The method according to claim 12, wherein the fog guide is constructed and arranged to avoid drops of water vapor from condensing and dripping back into the body.

19. The method according to claim 12, further comprising supplying water to the ultrasonic transducer.

20. The method according to claim 12, wherein the scrubber is used to reduce toxic gases from confined animal feeding operations.

21. The method according to claim 12, wherein the scrubber is used to reduce odors from bedpans, soiled linens, wound cleaning and maintenance cleanin in medical facilities.

22. The method according to claim 12, wherein the scrubber is used to reduce volatile amines and fumes from embalming fluids containing formaldehyde formulations.

23. The method according to claim 12, wherein the scrubber is used to suppress volatile organics compounds in a workplace.

24. The method according to claim 12, wherein the scrubber is used to eliminate odors and corrosion preventions from hydrogen sulfide in small areas.

25. The method according to claim 12, wherein the scrubber is used to eliminate food odors, tobacco smoke and body odor.

26. The method according to claim 12, wherein the scrubber is used to decontaminate rooms of allergens, molds and other biological pollutants.
